(19) United States
(12) Patent Application Publication
(10) Pub. No.: US 2009/0163104 A1
(43) Pub. Date: Jun. 25, 2009

(54) PRESS FABRIC FOR A MACHINE FOR THE PRODUCTION OF WEB MATERIAL AND METHOD TO PRODUCE SAID PRESS FABRIC

(76) Inventors: Arved Westerkamp, Dettingen/Erms (DE); Hubert Walkenhaus, Kerpen (DE); Robert Eberhardt, Ellwangen (DE)

Correspondence Address: TAYLOR & AUST, P.C., P.O. Box 560, 142. S Main Street, Avilla, IN, 46710, US

(21) Appl. No.: 12/328,217

(22) Filed: Dec. 4, 2008

(30) Foreign Application Priority Data
Dec. 21, 2007 (DE) 10 2007 055 801.7

(51) Int. Cl. B32B 27/12; B29C 63/00

(52) U.S. Cl. 442/394; 264/171.1

(57) ABSTRACT

The invention relates to a press fabric for a machine for the production of web material, especially paper or cardboard, including a carrying structure and at least one layer of fibrous material, whereby at least one of the layers of fibrous material, together with a polymeric material forms a permeable composite structure whereby the polymeric material partially fills and/or bridges the hollow spaces which are formed between fibers in this layer. The polymeric material forms a single component and permeable polymeric layer.

### BACKGROUND OF THE INVENTION

1. Field of the Invention

The current invention relates to a fabric, especially a press felt for a machine for the production of web material, especially paper or cardboard, and to a method to produce said fabric.

2. Description of the Related Art

The continuous press fabrics utilized, for example in press sections in paper machines move together with the web material which is to be manufactured through one or several press nips where, for example by way of two rolls pressing together, the press fabric and the web material which is to be produced and which runs between them is being compressed on the one hand, and liquid is squeezed from it on the other hand. The squeezed out liquid is to be removed by, or through, the press fabric. For this to occur it is necessary to provide this press fabric with a permeable structure, or a structure with hollow spaces, suitable for absorption of the liquid. A structure of this type however, obviously is also subject to press loads occurring in the area of a press nip. Therefore there is the danger of material fatigue due to the constant compression and relaxation, or that the porosity and thereby the available hollow spaces could be greatly reduced over the duration of the operation.

In order to provide a long lasting permeable structure, at least segments for example, of one or several non-woven layers may be filled for example with an elastomer polymeric material. This however presents the risk that the polymeric material separates from the non-woven layer during operation, thereby leading to a greatly reduced water absorption capacity. The risk of separation of the polymeric material from the non-woven layer exists especially when the polymeric material is located in the area of the web material contact surface of the press fabric and is subjected to a continuous high pressure water jet during operation.

What is needed in the art is a press fabric for a machine for the production of web material, especially paper or cardboard, and a method to produce said press fabric with which improved liquid removal properties and a greater stability under load can be achieved.

### SUMMARY OF THE INVENTION

The present invention provides, according to a first aspect of the current invention, a press fabric for a machine for the production of web material, especially paper or cardboard, including a carrying structure and at least one layer of fibrous material, whereby at least one of the layers of fibrous material, together with a polymeric material forms a fluid-permeable composite structure whereby the polymeric material only partially fills and/or bridges the hollow spaces which are formed between fibers in this layer, thereby creating a single component and fluid-permeable polymeric layer.

In other words a single-component and permeable polymeric layer is created which extends in the layer of fibrous material and which is embedded at least partially into the layer of fibrous material. The polymeric layer is firmly bonded with the fibers, whereby said fibers are at least partially embedded into said polymeric layer.

A single component polymeric layer is to be understood to be a polymeric layer which is formed from a single continuous component. In order to provide permeability, openings extend though the polymeric layer, whereby the openings in the polymeric layer are formed in that the polymeric material which forms the polymeric layer fills and/or bridges the hollow spaces between the fibers of the fibrous layer only partially. To verify that the permeable polymeric layer is indeed a single component, the fibrous material—if it is for example polyamide—can be leached out for example with formic acid.

The press fabric is especially fluid-permeable, for example water permeable.

The single component and permeable polymeric layer forms a permeable composite structure with fibers in the fibrous layer which provides a high water drainage capacity and which does not compress much during operation. Due to the fact that the polymeric material forms a single component polymeric layer, the polymeric material clearly separates from the layer of fibrous material less easily when under the influence of shear forces or high pressure water jets, than is the case with polymeric material which only forms a multitude of disconnected polymeric agglomerates in the fibrous material.

The single component and permeable polymeric layer preferably extends along the entire length and across the entire width of the layer of fibrous material. In this scenario the polymeric layer therefore forms an independent layer within the layer of fibrous material. This provides a press fabric which possesses constant characteristics across its width, for example dewatering capacity, rebound capacity, etc.

Alternatively it may be useful for the purpose of a targeted local manipulation of the characteristics of the inventive press fabric if the polymeric layer extends along the entire length and only across part of the width of the layer of fibrous material. In this context it is feasible, for example, to provide a polymeric layer in the area of the respective longitudinal edge in the layer of fibrous material which respectively only extends over a section of the width of the fibrous material layer. It is also feasible that the polymeric layer extends only in the central area of the fibrous material layer and that no polymeric layer is located in the area of the two longitudinal edges of the fibrous material layer.

The polymeric layer is preferably elastically compressible. Here the polymeric layer may have hardness in the range of 50 to 97 Shore A.

The polymeric material which forms the polymeric layer preferably includes an elastomer polymer, whereby the polymeric material is especially an elastomer polymer, for example an elastomer polyurethane.

For example, the polymeric material which forms the polymeric layer, either alone or in combination, includes for example a thermoplastic elastomer, especially a thermoplastic elastomer polyurethane, a polyether mass polyamide, a polyamide (PA) preferably of types PA 11, PA 12, PA 6.10 or PA 6.12. Especially the second polymeric material is one of the aforementioned materials.

The polymeric layer is in fact fluid permeable, however the polymeric material forming said polymeric layer is preferably actually fluid impermeable. The permeability of the polymeric layer is created in that the polymeric material only partially fills and/or bridges hollow spaces which are formed between fibers in the layer of fibrous material, thereby creating dewatering channels.

It is significant for a plurality of applications if the polymeric layer has a thickness in the range of approx. 0.05 mm to approx. 1.5 mm, preferably approx. 0.05 mm to approx. 1.0 mm.

In addition it is possible that the polymeric layer extends over the entire thickness of the fibrous material layer or alternatively, that the polymeric layer extends only over a part of the thickness of the fibrous material layer.

Particularly in order to provide a mark-free web material contact surface it may be useful if the layer of fibrous material containing the polymeric layer provides the web material contact surface of the press fabric, whereby the polymeric layer is located preferably in the area of the web material contact surface, so that the permeable composite structure provides the web material contact surface.

In this scenario the polymeric layer therefore extends in the area of the web material contact surface and provides large local surface elements, thereby producing clearly lower local pressure differentials upon the web material contact surface when the inventive press fabric runs through a press nip than would be the case if a non-coated fibrous layer were to provide the web material contact surface. This has an especially positive effect upon a uniform and mark free dewatering of the web in the press nip.

In order to affect specifically only the web material contact surface of the press fabric, without affecting its volume area it is useful if the polymeric layer—beginning from the web material contact surface—extends to a depth of 10% to 50%, preferably to a depth of 10% to 30%, more especially to a depth of 10% to 20% relative to the entire thickness of the press fabric. Hereby essentially only the web material surface is affected by the permeable and single-component polymeric layer.

In order to increase the abrasion resistance of the inventive press fabric it is also useful when the fibrous material containing the polymeric layer provides a machine contact surface of the press fabric, especially when the polymeric layer is located in the area of the machine contact surface, so that the permeable composite structure provides the machine contact surface of the press fabric.

To positively influence a long-term stable water absorption capacity it can be significant if the fibrous material layer containing the polymeric material is located between a fibrous material layer providing the web material contact surface and the carrying structure.

An additional embodiment of the invention provides that an additional polymeric material is located in the layer of fibrous material containing the polymeric layer which coats the fibers in this layer at least partially with a film.

In this embodiment the effects generated by the two polymeric materials conspire together. The fibers or at least part of them, are coated with the additional film-forming polymeric material and are thereby structurally supported and strengthened. This coating may already create a cross-linkage between the individual fibers so that a clearly better rebound characteristic can be combined with reduced material fatigue when considering the elastic characteristics of the polymeric material provided for the coating. Because of the continuing presence of the polymeric material which forms a permeable composite structure with the layer of fibrous material and which especially bridges and/or fills hollow spaces between the fibers of the at least one fibrous layer, the water absorption and water removal characteristic of this layer can be purposefully adjusted.

To this end the polymeric material forming the polymeric layer is preferably at least partially, especially completely adhered to sections of the fibers which are already coated with the additional polymeric material which forms the film.

In this scenario the additional polymeric material which forms the film acts as bonding agent between the polymeric material and the fibers of the at least one fibrous layer, thereby clearly improving the bond of the polymeric layer to the fibers of the fibrous layer.

Alternatively, or in addition to the aforementioned, it is conceivable that the additional polymeric material is provided in another layer than in the layer of fibrous material containing the polymeric layer and coats the fibers of said layer at least partially with a film. It is therefore conceivable, for example, that the polymeric material which represents the single-component and permeable polymeric layer is placed in the layer providing the web material contact surface. In contrast, the additional polymeric material which forms the film is contained in a layer of fibrous material which is located between the layer of fibrous material providing the web material contact surface and the carrying structure.

The additional polymeric material may include an elastomer polymer. Especially, the additional polymeric material is an elastomer polymer.

Preferably at least some of the fibers of the at least one fibrous layer are bonded with each other at fiber cross points and/or fiber contact points through the additional polymeric material that forms the film. Through bonding of the fibers in the layer a connected mesh structure consisting of interconnected fibers is created. This mesh structure contributes considerably and positively to the elasticity characteristics and the rebound capacity of the at least one layer of fibrous material.

As will be addressed later, the additional polymeric material may for example by applied in form of an aqueous dispersion of particle shaped polymeric material into the at least one layer of fibrous material. Such aqueous dispersions are known, for example, under the name “witcobond polymer dispersion” and are marketed for example by Baxenden Chemicals Ltd., England.

Preferably the additional polymeric material with which the fibers are coated has a higher melting point than the polymeric fabric which forms the single-component and permeable polymeric layer. This allows the polymeric material which forms the polymeric layer to be added after the fibers were already coated with the film of the additional polymeric material, without the film which coats the fibers being impaired by the heating necessary for melting of the base material for the polymeric material which forms the polymeric layer.

The film consisting of the additional polymeric material which coats at least sections of the fibers has preferably a thickness in the range of 1 μm to 20 μm.

At least some of the fibers of the at least one layer of fibrous material may be coated with several film layers of additional polymeric materials. It is conceivable in this context that at least some of the several film layers have different characteristics when compared to each other. These different characteristics can for example result from comparatively different additional polymeric materials which are used for the respective film layers.

Preferably, the polymeric material and the additional polymeric material have different elastic properties when compared with each other.

Beginning at the web material contact surface the additional polymeric material which coats the fibers of the at least one fibrous layer can generally extend to a depth of 10% to 100%, preferably to a depth of 30% to 100%, more especially preferably to a depth of 50% to 100%, relative to the overall thickness of the press fabric. Desirable bonding of the various layers of fibrous material with each other and with the carrying structure can be achieved by complete penetration of the press fabric with the additional polymeric material.

According to an additional aspect of the present invention, the present invention provides a method for the manufacture of a press fabric used in the production of web material, including the following measures:

a) Provision of at least one layer (20) of fibrous material,

b) Furnishing of polymeric material into at least one of the fibrous layers and creation of a permeable composite structure from the polymeric material and fibers of said fibrous layer by causing the polymeric material to only partially fill and/or bridge the hollow spaces between these fibers, thereby creating a single-component and permeable polymeric layer.

An advancement of the inventive method provides that the measure b) includes furnishing of the polymeric layer forming polymeric material in the form of particles in preferably an aqueous dispersion into the at least one layer of fibrous material, as well as melting of the polymeric material which was furnished in the form of particles into the at least one fibrous layer. In this variation the permeable composite structure which includes the polymeric material is created in that the polymeric material is melted following its addition into the at least one layer of fibrous material, adheres to the fibers and in that the melted polymeric material subsequently again solidifies, adhering to the fibers.

Here, liquid may be removed, for example drawn off, from the at least one layer of fibrous material prior to melting of the particle shaped polymeric material.

An additional preferred variation of the invention provides that under a measure c) an additional polymeric material is furnished into the fibrous layer and that the additional polymeric material is caused to form a film which coats the fibers of the fibrous layer.

Here, measure c) preferably includes adding of an aqueous dispersion of particle shaped, especially fine particle shaped, additional polymeric material into the at least one layer of fibrous material, as well as the removal of liquid from the dispersion added into the at least one fibrous layer. This means that the film coating the fibers of the at least one fibrous layer is formed essentially, especially completely, in that liquid is removed from dispersion of the particle shaped additional polymeric material and in that the polymeric particles adhere to the fibers in the form of a film.

In an additional process step the topography of the surface can then be influenced so that it assumes an embodiment that is advantageous for the web which will be produced on it. This includes preferably a smoothing process of the web material contact surface, for example by way of calendering. Therefore, an additional variation of the inventive method especially provides that subsequent to measure b) the web material contact surface of the press fabric is processed, especially smoothed and/or compressed in an additional step by use of pressure and/or temperature.

The measure b) may be implemented subsequent to measure c). This means that in the first instance the fibers are coated with the additional polymeric material intended for this process, for example through the application of a film-forming polymeric dispersion and subsequent drying, or removal of the liquid medium. The application of the preferably particle shaped polymeric material which forms the polymeric layer occurs only thereafter.

Alternatively it is of course also feasible to implement the measures b) and c) simultaneously.

Another advancement of the invention provides that, subsequent to measure b) the at least one layer of fibrous material which contains the polymeric material which forms the polymeric layer and the additional polymeric material which forms the film is compressed in an additional step by utilizing pressure and/or temperature. This achieves a pre-compacting and/or smoothing of this layer.

Preferably measure b) is implemented so that the polymeric material adheres at least partially, especially completely, on the segments of the fibers that are already coated with the film from the additional polymeric material. By utilizing the additional polymeric material which forms a film on the fibers, its adhesion on the fibers is considerably improved, for example after fusing the polymeric material that forms the layer, resulting in a clearly extended stability of the product performance on the paper machine. In addition to its function of strengthening the layer of fibrous material the film-forming polymeric material is required to improve the adhesion on the fibers of the polymeric material which forms the polymeric layer.

In order to bond the fibers of the at least one fibrous layer with each other, thereby creating a mesh of fibers, a preferred variation of the invention provides that under measure c) at least some of the fibers of the at least one fibrous layer are bonded with each other at fiber cross and/or fiber contact points through the first polymeric material.

For example, at least 50% of the particles of this fine particulate additional polymeric material are of a size in the range of 2.0 nm to 10 μm. In this context it is also conceivable that all particles of the fine particulate additional polymeric material are of a size of 10 μm maximum, especially of 2 μm maximum.

Size of a particle is to be understood generally as being its maximum spatial dimension in one direction, in other words length or width or height.

In order to be able to influence the fibers of the fibrous layer in a plurality of characteristics, a preferred embodiment of the invention provides that the measure c) is implemented several times in order to provide a multi-layered or multiply film that coats the fibers of the at least one layer of fibrous material. In order to influence the stability of the thereby coated fibers it can be provided that the fibers of the at least one fibrous layer are coated with different additional polymeric material in at least two implementations of the measure c).

The additional particle shaped polymeric material preferably includes an elastomer. The elastomer may specifically be polyurethane.

The additional polymeric material in particle form can especially be of a smaller particle size than the polymeric material in particle form.

In order to ensure that when melting the particulate polymeric material the film coating the fibers is not impaired, it is suggested that the particle shaped additional polymeric material used under the measure c) has a higher melting point that the particle shaped polymeric material used under the measure b).

Good results in the application capacity of the second polymeric material are achieved if 50 volume % of the total volume of all particles of the second polymeric material (average value d50) have a particle size between 20 μm and 150 μm, preferably between 50 μm and 100 μm.

The measure a) can include securing, preferably needling, of the at least one layer of fibrous material on a carrying structure. It is conceivable in this context that the bonding of the at least one layer of fibrous material with the carrying structure occurs prior to the application of the first and second polymeric material. Alternatively, the first and the second polymeric material may be applied first into the at least one layer of fibrous material, prior to its bonding with the carrying structure.

The carrying structure may be woven or randomly laid. It is conceivable in this context that the carrying structure includes a single component polymeric screen structure or is in the embodiment of same, as described for example in EP0285376. Generally, any flat textile structure is conceivable that would be able to function as a load-bearing carrying structure.

In addition, the at least one layer of fibrous material can be in the embodiment of a non-woven layer. Specifically, all layers of fibrous material in the press fabric are non-woven layers.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic sectional side view of an inventive press fabric, shown in an intermediate production phase;

FIG. 2 is an enlarged view of fibrous material with coated fibers and a permeable composite structure with polymeric material;

FIG. 3 is a cross sectional electron-microscopical micrographie of an inventive press felt;

FIG. 4 is an electron-microscopical micrographie of the web material contact side with a permeable composite structure, consisting of fibers and polymeric material;

FIG. 5 is an additional electron-microscopical micrographie of the web material contact surface with a permeable composite structure, consisting of fibers and polymeric material;

FIG. 6 is an exploded view of one variation of a single-component and permeable polymeric layer; and

FIG. 7 is an exploded view of an additional variation of a single-component and permeable polymeric layer.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

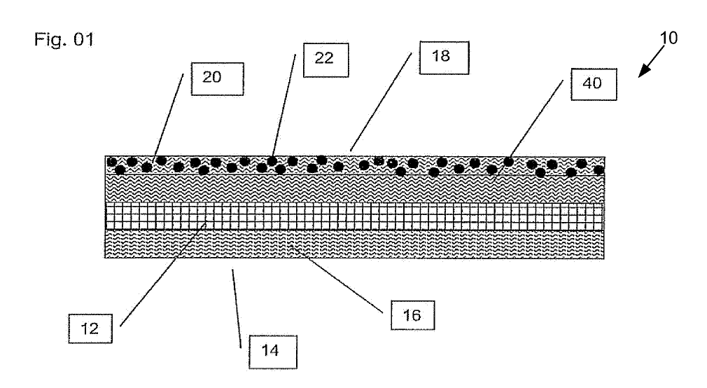

Referring now to the drawings, and more particularly to FIG. 1, there is shown a cross section of a press fabric 10 as is used, for example in a press section of a paper machine, in an intermediate production phase. The press fabric 10 includes a carrying structure 12 which may for example be in the embodiment of a woven fabric, a randomly laid fabric or a spiral link structure. On a machine contact surface 14 of the carrying structure 12 a layer 16 of fibrous material may be provided which may be bonded with the carrying structure 12, for example through needling. In the illustrated example a layer 20 and a layer 40 of fibrous material may be provided on a web material contact surface 18. These too are bonded rigidly with the carrying structure 12, preferably through needling.

The fibers of both layers 20 and 40 are coated with an additional film-forming polymeric material. The additional film-forming polymeric material may also coat the layers 12 and 16 completely or partially.

To this end a plurality of fine particles 22 of the additional polymeric material is applied onto the layer 20. These particles 22 preferably distribute themselves on the entire thickness of the layer 20 of fibrous material. To achieve this, an aqueous dispersion of fine particle shaped additional polymeric material 22 with a weight component of approximately 2 to 10% of the particles 22 is applied into the layer 20 from the direction of the web material contact surface 18.

Subsequently the liquid is removed from the layers 20, 40 and 16 of fibrous material and also the carrying structure 12, for example by way of evaporation, thereby creating a film which at least partially coats the fibers in this layer.

This method of adding a film-forming additional polymeric material, the drying process and film-forming process and consequently the coating and partial bonding or embedding of the fibers can be repeated several times, so that an accordingly multi-layered coating is created on the fibers. The materials utilized in this process can vary from film layer to film layer.

After the fibers of the layer 20 of fibrous material are coated to the greatest extent with the additional polymeric material, especially elastic polyurethane material, a second particle-shaped polymeric material can be applied in an additional process step, whereby the particles are dimensioned for example so that at least 50% of the total volume of all particles are of a size in the range of 20 μm to 120 μm. These particles too will distribute themselves in the interior volume area by adapting to the porosity of the layer 20 of already coated fibrous material, whereby due to the fundamentally larger particles, said particles accumulate increasingly in the area near the surface, that is in the area of the web material contact surface 18. If applicable, smaller particles can penetrate deeper into the overall structure (layers 20, 12, 16).

Subsequently a melting process occurs, whereby the now particle shaped polymeric material is melted and subsequently again solidified in such a way that, according to the current invention the polymeric material forms a single component and permeable polymeric layer which together with the fibers of layer 20 of fibrous material form a permeable composite structure.

In a solidified state the polymeric material forms a single-component and permeable polymeric layer, whereby the polymeric layer is located primarily in the area near the surface, that is in the area of the web material contact surface 18, thereby being able to form a mat-type polymeric formation on the surface of the layer 20 of fibrous material.

The proportion of the polymeric material which forms the polymeric layer in the fibrous material layer 20 is preferably in the range of 20 g/m² to 400 g/m². The tensile strength of the utilized polymeric material is preferably in the range between 5 and 1000 Mpa and, this polymeric material should have a melting point in the range between 120° C. and 220° C.

To provide the film from the additional polymeric material, polymeric dispersions can preferably be used, preferably based on polyurethane or polyacrylate but also others, or compounds of a plurality of polymer dispersions, for example Impranil DLH or Witcobond 372-95 or any similar material with characteristics in comparable ranges.

The tensile strength of the additional polymeric materials created from the polymeric dispersions may be in the range of 1 to 100 MPa, and the maximum elongation can be in the range of 100 to 1600%. The fine particulate additional particle material is applied preferably in an amount in the range of 20 g/m² to 500 g/m².

As already explained, these materials are applied so that they are applied preferably from the direction of the web material contact surface, preferably in the form of an aqueous dispersion, so that the particles can distribute themselves in the interior volume area of the layer of fibrous material. For this purpose at least 50% of the particles of the additional polymeric material should be of a size of 2 nm-10 μm.

Various thermoplastic polymeric materials, preferably elastic materials, for example polyurethane can be used for the creation of the polymeric layer. These may for example be polyurethanes which are available under trade name Estane, Pearlcoat, Unex, etc. and which possess the desired material properties. Alternatively polyether block polyamide (for example Pebax by Arkema) or polyamide, for example PA11, PA12, PA6, 12 which are available under the trade names Orgasol or Rilsan, or similar can also be used in combination with thermoplastic polyurethanes. Preferably materials or material mixtures having a high fused mass are utilized.

The polymeric material which forms the polymeric layer is utilized preferably in powder form and is applied preferably as an aqueous dispersion. In order to adjust the viscosity and stability of the dispersion required for a respective application process of the polymeric material, disperging agents may also find use as thickening agents. The polymeric material can also be applied dry, for example by way of sprinkling it.

For the application of the film-forming additional polymeric material a spraying process, splattering, slop-pad etc. can be used. For the application of the second polymeric material the aforementioned methods, as well as thermal application methods, may be used.

Alternatively, the film-forming coating of the fibrous material is also conceivable by way of polymer solutions.

It is self evident that the principles of the current invention may also be applied if several layers of fibrous material are utilized. It is also possible to implement the described measures—that is coating of the fibers and formation of the permeable composite structure—in one operational process. To this end, a dispersion consisting of a mixture of a fine particulate dispersion of the additional polymeric material together with a dispersion of coarser particles of the polymeric material, for example (D50=100 μm) may be applied in variable proportions. The coarser particles deposit themselves primarily on the surface of the fibers. A polymeric film forms on the fibers during the subsequent drying process, which additionally binds the coarser particles.

Subsequently a melting process occurs during which the coarser particles are melted. Since the polymeric material which forms the permeable polymeric layer has preferably a lower melting point than the polymeric material with which the fibers of the layer 20 of fibrous material were coated, heating need only occur to a temperature which will still melt the second particle material, which however does not impair the material of the fiber coating, leading to a strong bond between both materials.

In a softened state this provides a single-component and permeable layer in the hollow spaces of the layer 20 of fibrous material.

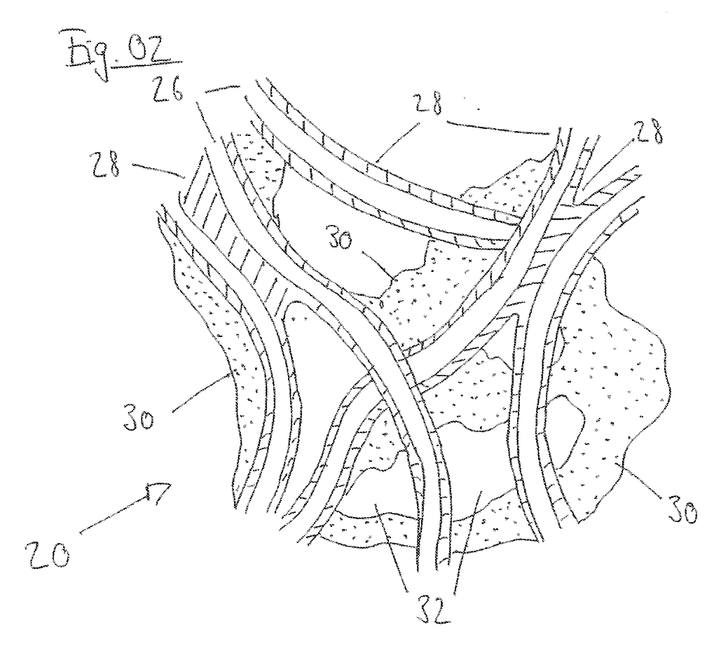

FIG. 2 illustrates an enlarged schematic view of the fiber structure in layer 20 of fibrous material.

Individual fibers 26 are recognized in FIG. 2 which are coated with a film 28 of the additional polymeric material. On the one hand the fibers 26 are strengthened through this film coating 28. On the other hand a bonding is created through the film 28 at the crossing points of the fibers 26, so that also the entire rigidity of the layer 20 of fibrous material increases. In addition, the single-component and permeable polymeric layer 30 forming polymeric material is recognized which primarily also accumulates in the area of the crossing points or in the vicinity of the fibers 26 which are already coated with the film 28, after it was melted and subsequently solidified. The pores or hollow spaces 32 which permit the liquid penetration through the layer 20 are located between the fibers 26 and the polymeric material areas 28, 30.

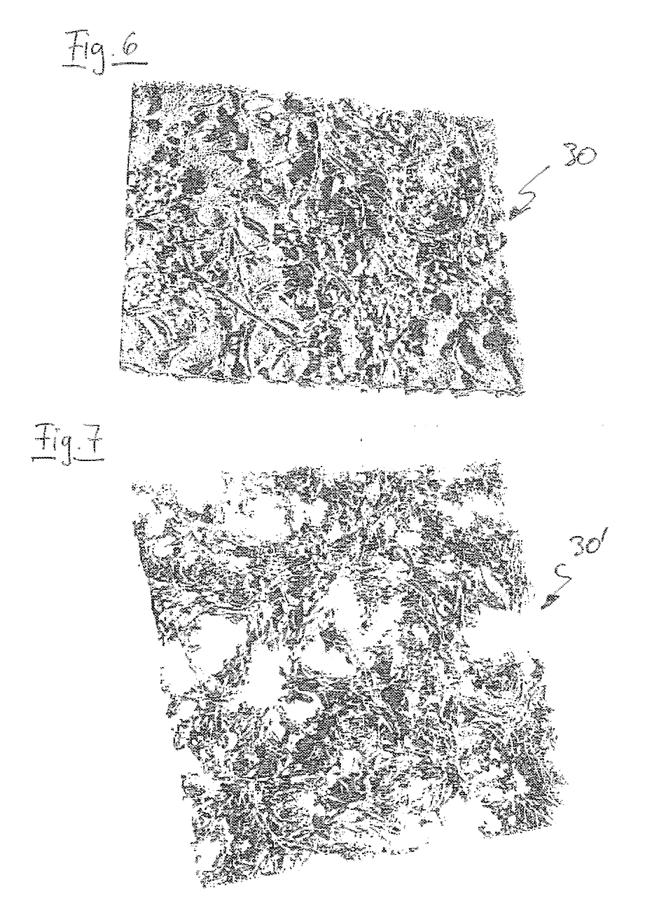

FIGS. 6 and 7 respectively illustrate an inventive single-component and permeable polymeric layer 30, 30′. FIGS. 6 and 7 show the polymeric layers separated, that is without the fibers 26 of the fibrous layer 20. The separated polymeric layers 30, 30′ are obtained after the fibrous material is separated out from the permeable composite structure which is formed from the fibers in layer 20 and the polymeric material. If the fibrous material consists of polyamide fibers, leaching out can be achieved for example with formic acid.

Both single-component and permeable polymeric layers 30, 30′ as illustrated in FIGS. 6 and 7 are formed from thermoplastic elastomer polyurethane and have a thickness in the range of approx. 0.1 mm. Both layers 30, 30′ are located in the area of the web material contact surface and, starting from the web material contact surface, extend to a depth of approx. 20%, relative to the entire thickness of the press fabric.

The two polymeric layers 30, 30′ differentiate essentially through a different filling ratio of the layer of fibrous material, when compared with each other. The polymeric layer 30 illustrated in FIG. 6 fills and/or bridges the hollow spaces 32 in this layer 20 to a greater extent than does the polymeric layer 30′ illustrated in FIG. 7.

It must be noted in this context that the porosity of the polymeric layers 30, 30′ is not created through a porosity of the polymeric material itself, but in that hollow spaces 32 between fibers 26 of the fibrous layer 20 are only partially filled and/or bridged.

Since the polymeric material which forms the permeable layer 30, 30′ preferably has a lower melting point than the additional polymeric material which forms the film with which the fibers 26 of the fibrous material layer 20 were coated, heating need only occur to a temperature which will still melt the particle shaped material, which however does not impair the additional polymeric material of the fiber coating. This creates a strong bond between both materials.

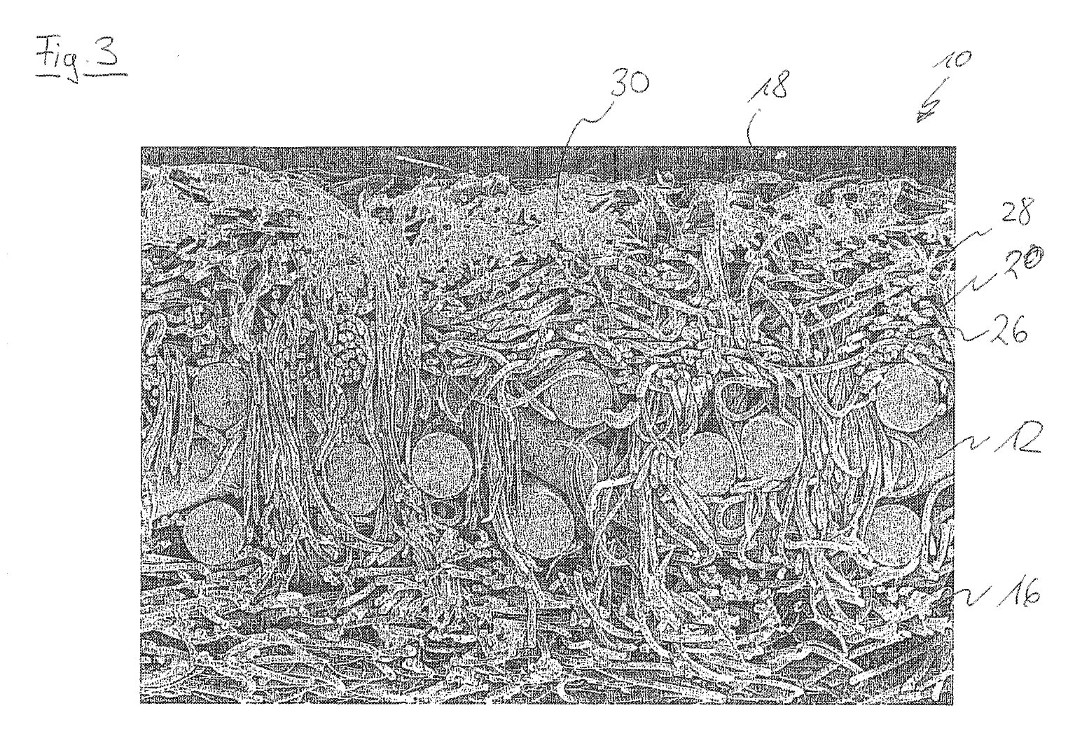

FIG. 3 illustrates a cross sectional electron-microscopical micrographie of an inventive press fabric 10 in the embodiment of a press felt.

The press fabric 10 includes a layer of fibrous material 20 containing fibers 26 which provides the web material contact surface 18. The machine contact surface 14 of the press fabric 10 is formed by a layer of fibrous material 16. A carrying structure 12 in the form of a woven fabric 12 is located between the two layers of fibrous material 20 and 16. The two layers of fibrous material 16 and 20, as well as the woven fabric 12 are firmly bonded with each other by way of needling.

The fibers 26 of the layer 20 are coated, essentially completely, with the film 28 formed by the additional polymeric material.

In the area of the web material contact surface 18 of the fibrous layer 20 a permeable composite structure is also formed from the polymeric material 30 and fibers 26 extending to a depth of approximately 20% relative to the entire thickness of the press fabric 10. The hollow spaces which are formed between the fibers 26 of the fibrous layer 20 are filled and bridged with the polymeric material in such a manner that the polymeric material forms a single-component and permeable polymeric layer.

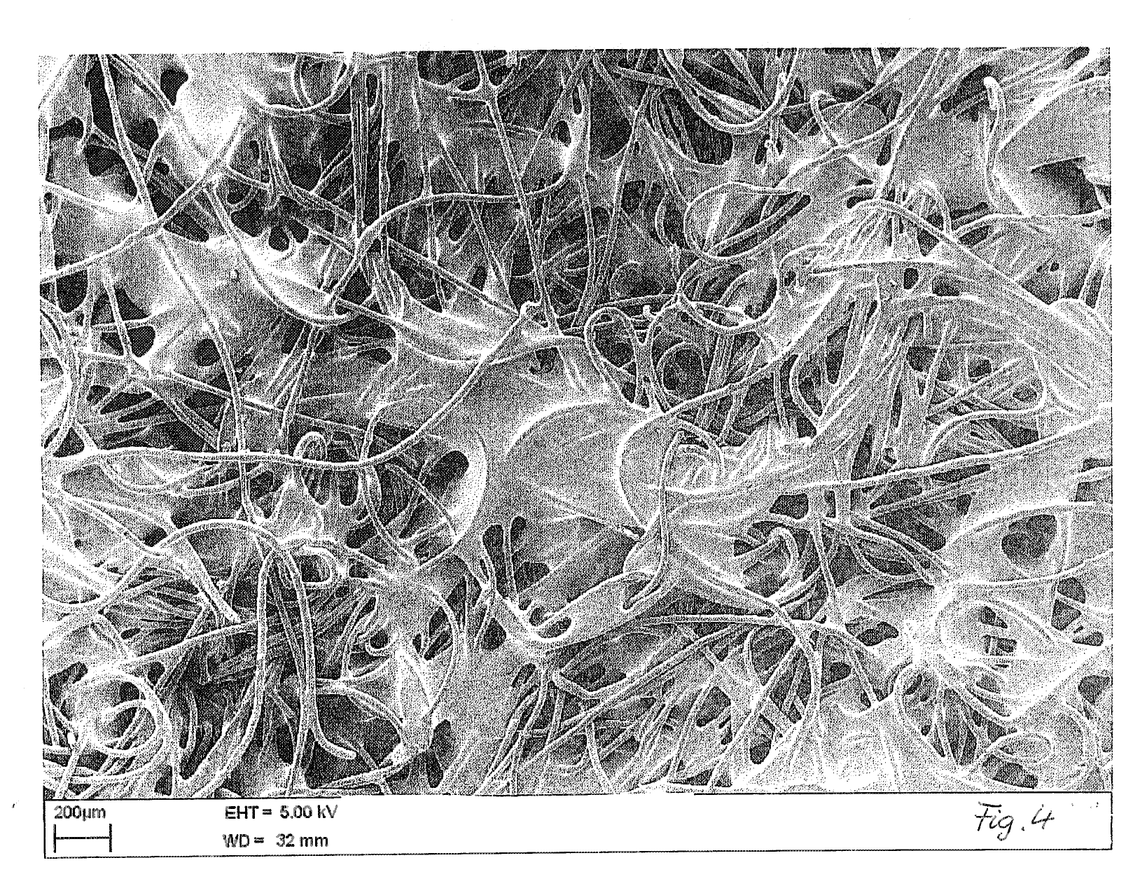

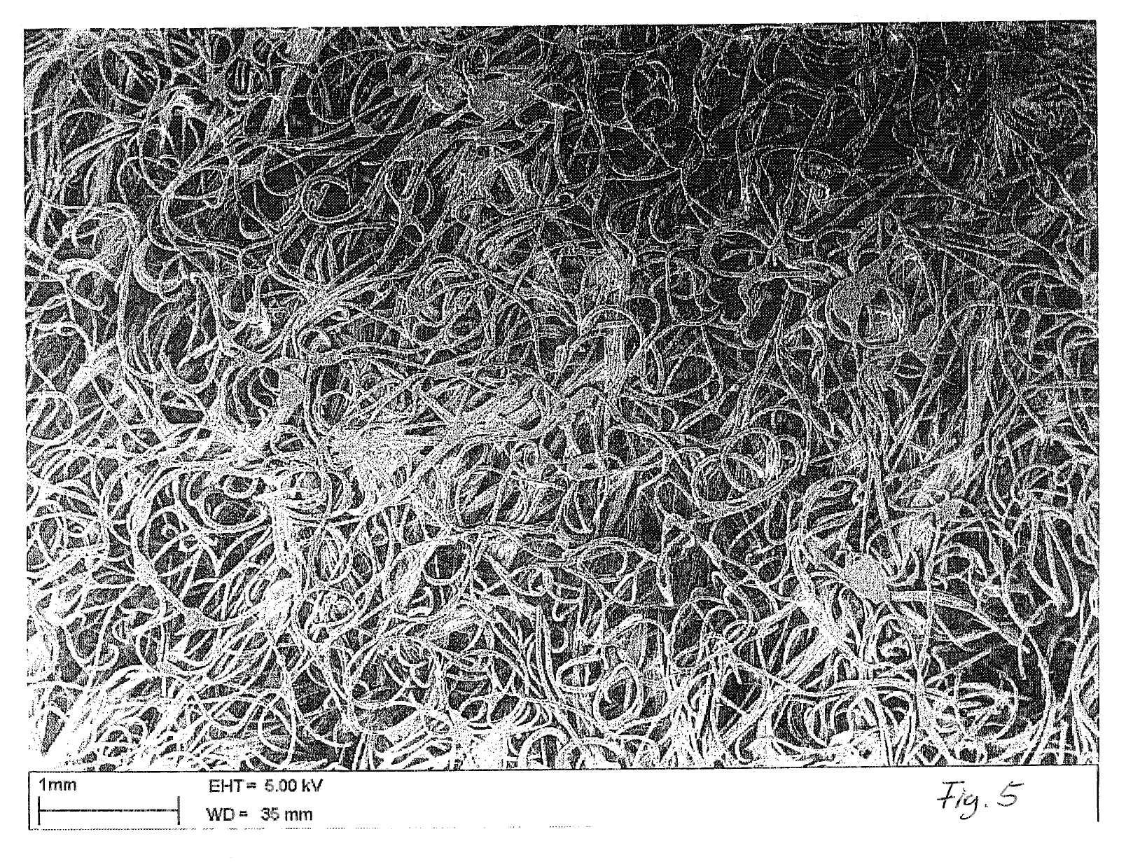

FIGS. 4 and 5 illustrate a top view of the web material contact surface 22 of such a layer 20 of polymeric material. One recognizes the fiber structure and the single-component and permeable polymeric layer with a multitude of pores which at least partially embeds said fibrous structure. This structure not only achieves an increased rigidity and rebound characteristic of the layer 20 of fibrous material, but at the same time the micro-structuring and possibly the surface energy of the added polymeric material on the surface also facilitates the release of a press fabric of this type at those locations where it is to be separated from the web material that is to be manufactured.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A press fabric for a machine for a production of a web of fibrous material, said press fabric comprising:
a carrying structure;
a layer of fibrous material including a plurality of fibers; and
a polymeric material, said layer of fibrous material together with said polymeric material forming a permeable composite structure in that said polymeric material only partially at least one of fills and bridges a plurality of hollow spaces which are formed between said plurality of fibers of said layer of fibrous material, said polymeric material forming a single-component and permeable polymeric layer.

2. The press fabric according to claim 1, wherein said polymeric layer extends over a total length and a total width of said layer of fibrous material.

3. The press fabric according to claim 1, wherein said polymeric layer extends over a total length and only a part of a total width of said layer of fibrous material.

4. The press fabric according to claim 1, wherein said polymeric layer is elastically compressible.

5. The press fabric according to claim 1, wherein said polymeric material which forms said polymeric layer is an elastomer.

6. The press fabric according to claim 1, wherein said polymeric material which forms said polymeric layer is an elastomer polyurethane.

7. The press fabric according to claim 1, wherein said polymeric material which forms said polymeric layer alone one of includes and is one of a thermoplastic elastomer, a thermoplastic elastomer polyurethane, a polyether mass polyamide, a polyamide, and a polyamide selected from the group consisting of type polyamide 11, type polyamide 12, type polyamide 6.10, and type polyamide 6.12.

8. The press fabric according to claim 1, wherein said polymeric material is actually fluid impermeable.

9. The press fabric according to claim 1, wherein said polymeric layer extends over a thickness in a range of approximately 0.05 mm to approximately 1.5 mm.

10. The press fabric according to claim 1, wherein said polymeric layer extends over a thickness in a range of approximately 0.05 mm to approximately 1.0 mm.

11. The press fabric according to claim 1, wherein said polymeric layer extends over an entire thickness of said layer of fibrous material.

12. The press fabric according to claim 1, wherein said polymeric layer extends only over a part of a total thickness of said layer of fibrous material.

13. The press fabric according to claim 1, wherein said layer of fibrous material contains said polymeric layer and provides a web material contact surface.

14. The press fabric according to claim 13, wherein said polymeric layer includes said web material contact surface.

15. The press fabric according to claim 14, wherein, beginning at said web material contact surface, said polymeric layer extends to a depth of 10% to 30% relative to a total thickness of the press fabric.

16. The press fabric according to claim 1, wherein said layer of fibrous material contains said polymeric layer and provides a machine contact surface.

17. The press fabric according to claim 1, further including an additional layer of fibrous material which provides a web material contact surface, said layer of fibrous material containing said polymeric material and being located between said additional layer of fibrous material and said carrying structure.

18. The press fabric according to claim 1, wherein said layer of fibrous material contains said polymeric layer, and, in said layer of fibrous material, an additional polymeric material is located which at least partially coats with a film said plurality of fibers in said layer of fibrous material.

19. The press fabric according to claim 18, wherein said polymeric material forming said polymeric layer is at least partially adhered to at least a plurality of sections of said plurality of fibers which are already coated with said additional polymeric material which forms said film.

20. The press fabric according to claim 19, wherein said film which coats at least said plurality of sections of said plurality of fibers has a thickness in a range of 1 μm to 20 μm.

21. The press fabric according to claim 18, wherein said polymeric material forming said polymeric layer is completely adhered to at least a plurality of sections of said plurality of fibers which are already coated with said additional polymeric material which forms said film.

22. The press fabric according to claim 18, wherein at least some of said plurality of fibers are bonded with each other at least one of at a plurality of fiber cross points and at a plurality of fiber contact points through said additional polymeric material that forms said film.

23. The press fabric according to claim 18, wherein said additional polymeric material includes an elastomer polymer.

24. The press fabric according to claim 18, wherein said additional polymeric material is an elastomer polymer.

25. The press fabric according to claim 18, wherein at least a part of said plurality of fibers is coated with a plurality of film layers of said additional polymeric material.

26. The press fabric according to claim 25, wherein said plurality of film layers have different properties compared with each other.

27. The press fabric according to claims 18, wherein the press fabric includes a web material contact surface, and wherein, beginning at said web material contact surface, said additional polymeric material which coats said plurality of fibers with said film extends to a depth of 10% to 100% relative to an overall thickness of the press fabric.

28. The press fabric according to claims 18, wherein the press fabric includes a web material contact surface, and wherein, beginning at said web material contact surface, said additional polymeric material which coats said plurality of fibers with said film extends to a depth of 30% to 100% relative to an overall thickness of the press fabric.

29. The press fabric according to claims 18, wherein the press fabric includes a web material contact surface, and wherein, beginning at said web material contact surface, said additional polymeric material which coats said plurality of fibers with said film extends to a depth of 50% to 100% relative to an overall thickness of the press fabric.

30. The press fabric according to claim 18, wherein 80% of said polymeric layer is located on 80% of a total thickness of the press fabric.

31. The press fabric according to claim 18, wherein 80% of said polymeric layer is located on 40% of a total thickness of the press fabric.

32. The press fabric according to claim 18, wherein said additional polymeric material which coats said plurality of fibers with said film has a higher melting point than said polymeric material which forms said polymeric layer.

33. A method for manufacturing a press fabric used in producing a web of fibrous material, said method comprising the steps of:
(a) providing that the press fabric includes a layer of fibrous material including a plurality of fibers; and
(b) furnishing a polymeric material into said layer of fibrous material and creating a permeable composite structure from said polymeric material and said plurality of fibers of said layer of fibrous material by causing said polymeric material to only partially at least one of fill and bridge a plurality of hollow spaces between said plurality of fibers, thereby creating a single-component and permeable polymeric layer.

34. The method according to claim 33, wherein said step (b) further includes (1) furnishing said polymeric material as a plurality of particles in an aqueous dispersion into said layer of fibrous material and (2) melting said polymeric material which was furnished as said plurality of particles into said layer of fibrous material.

35. The method according to claim 34, further including removing a liquid from said dispersion in said layer of fibrous material prior to melting said polymeric material furnished as said plurality of particles.

36. The method according to claim 33, further including (c) furnishing an additional polymeric material into said layer of fibrous material and causing said additional polymeric material to form a film which coats said plurality of fibers of said layer of fibrous material.

37. The method according to claim 36, wherein said step (c) further includes adding an aqueous dispersion of particle-shaped said additional polymeric material into said layer of fibrous material and removing a liquid from said dispersion added into said layer of fibrous material.

38. The method according to claim 37, wherein said particle-shaped additional polymeric material is a fine said particle-shaped additional polymeric material.

39. The method according to claim 37, wherein said polymeric material adheres at least partially on a plurality of segments of said plurality of fibers, said plurality of segments being coated with said additional polymeric material.

40. The method according to claim 37, wherein said polymeric material adheres completely on a plurality of segments of said plurality of fibers, said plurality of segments being coated with said additional polymeric material.

41. The method according to claim 37, wherein subsequent to said step (b) said layer of fibrous material is compressed in an additional step by utilizing at least one of pressure and temperature.

42. The method according to claim 37, wherein at least 50% of said particle-shaped additional polymeric material are of a size in a range of 2.0 nm to 10 μm.

43. The method according to claim 37, wherein said particle-shaped additional polymeric material includes a plurality of particles, all of said plurality of particles of said particle-shaped additional polymeric material being of a size of 10 μm maximum.

44. The method according to claim 37, wherein said particle-shaped additional polymeric material includes a plurality of particles, all of said plurality of particles of said particle-shaped additional polymeric material being of a size of 2 μm maximum.

45. The method according to claim 37, wherein said step (c) is implemented a plurality of times in order to provide a multi-layered said film that coats said plurality of fibers of said layer of fibrous material.

46. The method in accordance with claim 45, wherein said plurality of fibers of said layer of fibrous material are coated with a different said additional polymeric material in at least two implementations of said step (c).

47. The method according to claim 37, wherein said particle-shaped additional polymeric material includes an elastomer.

48. The method according to claim 47, wherein said particle-shaped additional polymeric material is said elastomer.

49. The method according to claim 47, wherein said elastomer includes a polyurethane.

50. The method according to claim 47, wherein said elastomer is an elastomer polyurethane.

51. The method according to claim 37, wherein said step (b) further includes (1) furnishing said polymeric material as a plurality of particles in a dispersion into said layer of fibrous material and (2) melting said polymeric material which was furnished as said plurality of particles into said layer of fibrous material, said particle-shaped additional polymeric material having a smaller particle size than said polymeric material furnished as said plurality of particles.

52. The method according to claim 37, wherein said step (b) further includes (1) furnishing said polymeric material as a plurality of particles in a dispersion into said layer of fibrous material and (2) melting said polymeric material which was furnished as said plurality of particles into said layer of fibrous material, said particle-shaped additional polymeric material having a higher melting point than said polymeric material furnished as said plurality of particles.

53. The method according to claim 37, wherein said step (b) further includes (1) furnishing said polymeric material as a plurality of particles in a dispersion into said layer of fibrous material and (2) melting said polymeric material which was furnished as said plurality of particles into said layer of fibrous material, an average value (d50) of a particle size of said polymeric material furnished as said plurality of particles being between 20 μm and 150 μm.

54. The method according to claim 37, wherein said step (b) further includes (1) furnishing said polymeric material as a plurality of particles in a dispersion into said layer of fibrous material and (2) melting said polymeric material which was furnished as said plurality of particles into said layer of fibrous material, an average value (d50) of a particle size of said polymeric material furnished as said plurality of particles being between 50 μm and 100 μm.

55. The method according to claim 36, wherein said step (c) is implemented prior to said step (b).

56. The method according to claim 36, wherein said steps (b) and (c) are implemented simultaneously.

57. The method according to claim 36, wherein said step (a) includes securing said layer of fibrous material on a carrying structure.

58. The method according to claim 57, wherein said securing includes needling said layer of fibrous material on a carrying structure.

59. The method according to claim 57, wherein said carrying structure is one of woven and randomly laid.

60. The method according to claim 36, wherein said layer of fibrous material is one of felt and non-woven.

61. The method according to claim 36, wherein according to said step (c) at least some of said plurality of fibers of said layer of fibrous material are bonded with each other at least one of at a plurality of fiber cross points and at a plurality of fiber contact points through said additional polymeric material.
